(19) United States
(12) Patent Application Publication
(10) Pub. No.: US 2011/0024411 A1
(43) Pub. Date: Feb. 3, 2011

(54) COMBINED HEATER AND CONVEYOR

(75) Inventor: Richard Holliday, Leominster (GB)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: OSCI-TEK LIMITED, Stoke-on-Trent, Staffordshire (GB)

(21) Appl. No.: 12/811,082

(22) PCT Filed: Dec. 24, 2008
(86) PCT No.: PCT/GB08/04292

§ 371 Date: Oct. 4, 2010

(30) Foreign Application Priority Data
Dec. 28, 2007 (GB) 0725308.1

(51) Int. Cl. H05B 6/70; H05B 6/78

(52) U.S. Cl. 219/690; 219/700

(57) ABSTRACT

A combined heating and conveyor apparatus for use in heating a bulk solid product, such as a food product, comprises a hollow channel member having a base that forms a conveying surface along which product is to be moved, the channel member having at least one entrance region and one discharge region, an actuator which in use causes the channel member to vibrate in a manner which tends to cause product introduced to the channel at the entrance region to move towards the discharge region; and characterised in that the channel member functions as a microwave frequency closed waveguide, and a source of microwave radiation is connected to the channel member in such a way that the microwave radiation propagates along the channel member and is substantially retained within the channel member whereby, in use, the energy in the microwaves can be at least partially absorbed by the product that passes along the channel.

This invention relates to a combined heater and conveyor apparatus suitable for bulk solid products. It is especially suited to the heating of solid organic products such as food products including cooked potato crisps but may also have application in the extraction of oil and gases from other organic and non-organic solid products.

At present it is well known that a bulk solid product can be evenly heated by placing it on a conveyor and using the conveyor to move the product through a heated region. Radiant heating can be used, or microwave induced heating can be used. In the latter case, this has typically been achieved by placing a microwave horn over a region of conveyor and directing radiation down onto this region of conveyor from the horn. As the product passes through this region, it absorbs some of the energy in the microwaves and heats up.

Conveyors can be flat or elevated. They may comprise a moving belt onto which product is placed. The belt is wrapped around at least one drive wheel or roller and one driven wheel or roller. Rotation of the wheels causes the belt to move, which then carries the material through the heating region.

In another design, a fixed surface may be provided which is vibrated at high frequency. If the frequency and mode of vibration is correctly selected, the vibration can cause the product to move along the surface from one end to the other. In essence, the vibration of the surface must move it both up and down, and also from side to side, in the correct phase to make the product move across the surface.

In one particular arrangement of conveyor, a vibrating surface is provided that forms a helical chute wrapped around a support. The vibration can move the material up or down the chute, usually up. These are known as vibratory elevator conveyors. They are preferred over linear conveyors as they are more compact for a given length of travel of product. The skilled person will be familiar with the implementation of a conveyor of this type.

To date, heating of solid product in a vibratory elevator conveyor has been achieved in one of two ways. Firstly, the whole assembly may be heated by placing it within a chamber, and heating the whole chamber using heated air. Secondly, the channel can be provided with a jacket around its outside which is heated. The heat passes through the channel walls to heat the product by convection.

It has been appreciated by the applicant that with this type of prior art heater and conveyor apparatus it is very difficult to control the heating cycle of the material. Direct heating using a jacket offers perhaps the most flexibility, but it is considerably more complex to make because of the intricate design of the jacket.

According to a first aspect the invention provides a combined heating and conveyor apparatus for use in heating a bulk solid product, such as a food product, comprising:

a hollow channel member having a base that forms a conveying surface along which product is to be moved, the channel member having at least one entrance region and one discharge region;
an actuator which in use causes the channel member to vibrate in a manner which tends to cause product introduced to the channel at the entrance region to move towards the discharge region; and characterised in that: the channel member functions as a microwave frequency closed waveguide; and
a source of microwave radiation is connected to the channel member in such a way that the microwave radiation propagates along the channel member and is substantially retained within the channel member whereby, in use, the energy in the microwaves can be at least partially absorbed by the product that passes along the channel.

The apparatus in essence forms a vibratory conveyor in which the channel along which the solid product passes forms a waveguide and is filled with microwave energy that heats the product. Because the channel is a waveguide any radiation introduced to it from the source is trapped inside being reflected from the walls of the channel. Because the channel acts as a waveguide, the microwave radiation is largely (perhaps even totally) retained in the channel to give much lower radiation levels outside the channel. This ensures that all the energy is where it is needed in the channel with the product that is to be heated.

The channel may comprise a waveguide which is designed to work in the H0,1 mode. It may have an aspect ratio (height to width) of 2:1 or greater. It is not restricted to working in the H0,1 mode. The height may generally be greater than the width, and the width not less than half of the operating wavelength in free space, e.g. at 2.4 Ghz the width in the H direction (wide dimension) should not be less than 62.5 mm and at 902 Mhz should not be less than 166.2 mm.

The channel member may have electrically conductive walls and may comprise a hollow metallic cylindrical conductor. The channel may have a solid base, sides and top. It may have a box shaped cross section.

The source of microwave energy may emit radiation at a frequency that lies within the ISM (Industrial, Scientific and Medical) frequency bands. In the case of microwave heating the bands spans the range 902 Mhz to 915 Mhz and 24.Ghz to 2.5 Ghz. However, the invention should not be considered to be limited to these ranges in all embodiments. For instance frequencies and wavelengths listed in Table 1 may be used:

TABLE 1

| Frequency | Wavelength |
|---|---|
| 24 to 24.5 Ghz | 12.49 mm to 12.24 mm |
| 61 to 61.5 GHz | 4.91 mm to 4.87 mm |
| 122 to 123 Ghz | 2.46 mm to 2.44 mm |
| 244 to 246 Ghz | 1.23 mm to 1.22 mm |

At these higher frequencies the wavelength may be chosen to correspond to the length of long chain polymers in the solids to be heated.

Alternatively, instead of having solid walls and base, at least part of the channel member may be semi-solid. For example, the top, and at least part of the walls may be semi-solid with the base solid. By semi-solid we mean, for instance, that it may be formed from a skeleton framework or lattice of material. This gives access to the inside for the extraction of vapours and gasses that are given off during heating and also cleaning yet will continue to function as a waveguide provided that the normal flow of current along the wall is not interrupted.

The walls of the channel member may be electrically conductive, or may be surrounded by an electrically conductive material. For example the walls are made of metal with a high conductivity such as copper, aluminium or brass. For use with foodstuffs or pharmaceuticals and chemicals stainless steel may be used because it does not react with most substances. Use of the stainless steel for the waveguide is especially advantageous. Because of its low conductivity it will heat up due to Ohmic heat losses providing a heated channel that will aid heating of the product being heated in the microwave field.

The channel member may extend linearly along an axis. However, it is most preferred that it extends along a helical path which may be centred around a substantially vertical axis. Therefore, the channel member may be oriented with one end of the channel higher than the other, and the vibration means may cause the channel to vibrate in a way that causes solid material to move from the lower end towards the higher end.

The channel member may surround a central cylindrical support member.

The channel member comprises a plurality of interconnected sections, perhaps welded together, or may be formed as a single continuous part, perhaps as a casting.

The apparatus may include a feed through which bulk material can be fed to the channel. In the case of a vibratory elevator conveyor, the feed may comprise a tray into which the base of the channel is placed, the tray being loaded with product to be conveyed.

The microwave source may be connected to the channel member through a waveguide which is connected to the channel member through, for example, a Tee junction such as a magic tee or 3 db coupler. This may be located at any point along the channel member. Placing it in the middle is preferred.

The actuator may comprise one or more unbalanced motors, rotation of the motor causing the apparatus to vibrate. Preferably two motors operating in phase may be provided. Other actuators may be provided as well or instead of an unbalanced motor. For example, one or more solenoids may be provided which when energised and de-energised with a drive current cause the apparatus to vibrate.

The apparatus may be operated in air or in a full or partial vacuum by providing the channel member within the vacuum. Alternatively air may be pumped out of the channel member so that only the inside of the channel member is at lower than atmospheric pressure. Providing a vacuum may be helpful in extracting oils and vapours from the products that are heated as they pass through the channel member.

According to a second aspect the invention provides a method of heating a product comprising;

providing a product carrying channel which has the physical and electromagnetic properties required to function as a closed waveguide for microwave radiation;
vibrating the channel;
feeding product into one end of the channel, the product being carried to the other end of the channel by the vibration of the channel; and
applying microwaves to the inside of the channel such that the product absorbs at least part of the microwave energy as it passes along the channel.

According to a third aspect the invention provides a helical vibratory elevator which includes a feeder comprising a closed or semi-closed tube which functions as a microwave waveguide and which receives microwave radiation supplied from a microwave source.

The apparatus according to the invention can be used to heat a wide range of products. One particularly notable use proposed by the applicant is heating of crisps, such as potato crisps to extract oil from the crisps as liquid or vapour. This may then be reused in cooking or as a biofuel to run an engine. Protection for the use of the apparatus in method of extracting oil from potato crisps using heat is sought through this application.

The invention is applicable to heating many other products, stuffs or materials. A non-exhaustive list is set out in Table 2 at the end of this description.

There will now be described, by way of example only, one embodiment of the present invention with reference to and as illustrated in the accompanying drawings of which:

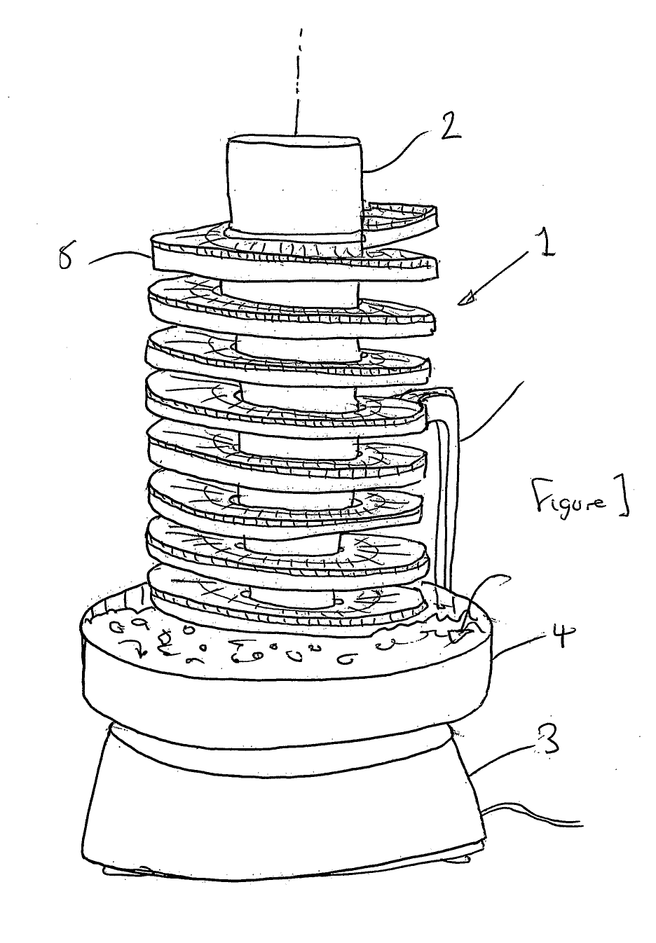

FIG. 1 is an isometric view of an embodiment of a combined heater and conveyor in accordance with the first aspect of the invention;

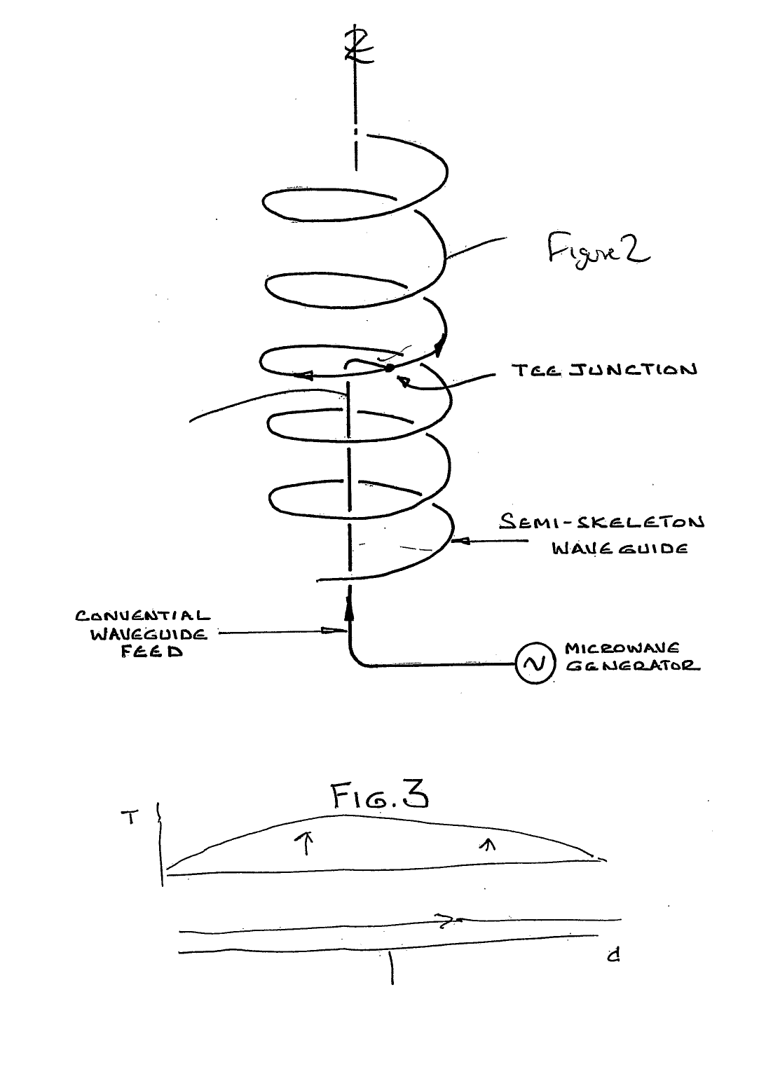

FIG. 2 is a diagram illustrating the flow path for microwaves in the apparatus of FIG. 1;

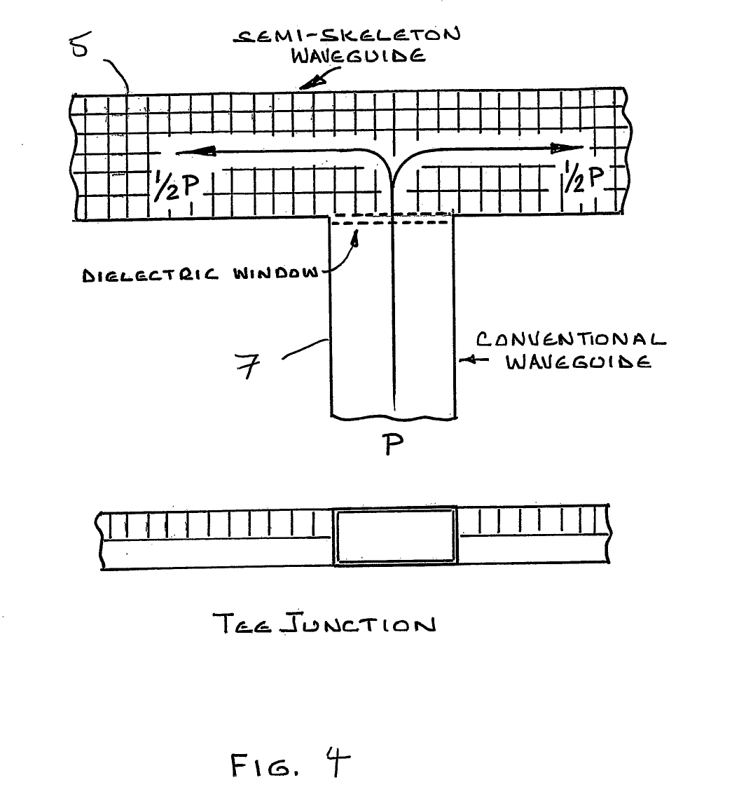

FIG. 3 is a graph showing on the Y-axis the heating temperature T of a product and on the X-axis its position as it travels from the bottom to the top of the apparatus of FIG. 1;

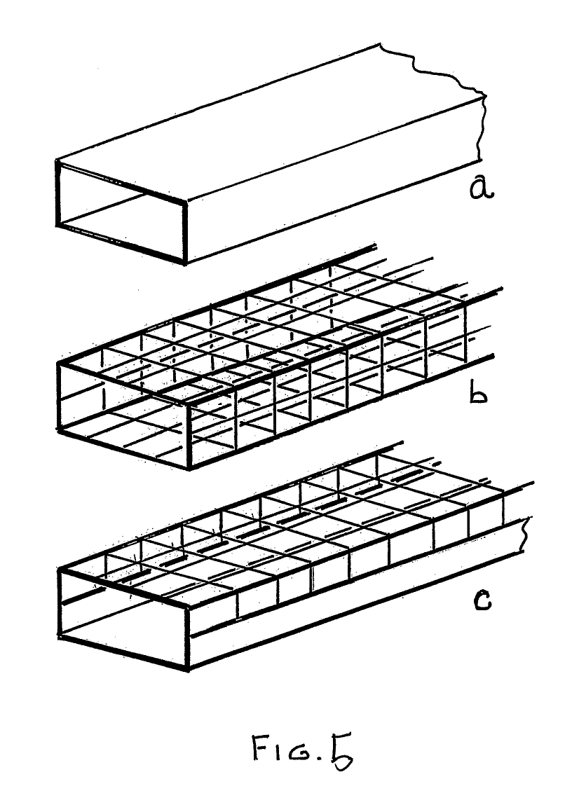

FIG. 4 is a detailed view of the feed for the microwaves into the channel; and

FIG. 5(a) to (c) are enlarged views of different arrangements of channel for use in an apparatus such as that shown in FIG. 1.

As shown in FIG. 1, a heating apparatus 1 for bulk product comprises a hollow central tubular support column 2 mounted on a base unit 3. The lower end of the column 2 is flared outward and turned upwards at its outer edge to form a bowl or trough 4. Fixed at several locations around the outside of the column 2 is a channel member 5 which defines a conveyor surface. The channel member comprises a helical metallic tube which wraps around the column several times and extends from the bottom of the column to a point close to the top. The channel member has a rectangular cross section. Although not visible in the figures, this is made from a plurality of segments which each wind round the column through an angle of 90 degrees—four segments being needed to make one complete loop around the column.

The lower end of the channel member 5 is located within the bowl 4, and the upper end is located at the top of the support tube 2. The bottom surface of the channel member (which cannot be seen in the view of FIG. 1) forms a conveying surface or path along which a product will move from the bowl 4 to the top of the support column 2.

A mechanical actuator (not shown) is located within the base unit 3. It could, however, be located elsewhere if space is limited at the base unit 3. The purpose of the mechanical actuator is to set up vibrations within the support column 2 and hence the channel member. Many different types of actuator can be provided (and the invention is not to be limited to any particular type). In this embodiment, it comprises two unbalanced motors which rotate when connected to a source of electrical current. Provided that the correct frequency and modes of vibration are set up in the support column, the helical tube will function as a vibratory feeder. Product, such as grain, poured into the bowl moves up the tube due to these vibrations until it exits from the top of the tube.

At a height about half way up the support column 2, a tee connection 6 is made to the channel member. A suitable Tee connection is shown in detail in FIG. 4 of the accompanying drawings. This comprises a further section of metallic tube 7 of rectangular cross section which joins the helical channel member 5 at right angles. This further tube forms a waveguide. A dielectric window seals the inside of the tube 7 from the inside of the channel member 5. A source of microwave radiation (not shown) of power P is then connected to the end of the further section of tube 7 furthest from the helical channel member 5.

Both the further tube 7 and channel member 5 are hollow and have electrically conductive walls. This can be achieved simply by making them both from folded sheet metal.

The dimensions of the channel member and guide will depend on the overall size of the unit that is required. In this embodiment, the feed wave guide has dimensions compatible with 2.4 Ghz radiation and has internal dimensions of 88.9 mm by 44.45 mm. The channel member could be wider and for example it may have internal dimensions of 150 mm by 50 mm deep. The Tee junction could be fed up the inside of the support column for the helical channel, and the diameter of the support column can be selected to give as long a heating path as required taking into account its height and hence the number of turns of the channel member 5.

The further tube 7 and channel member 5 therefore functions as microwave waveguides, and the microwaves P that enter the further tube pass into the main helical channel member 5. In fact, they will split equally so that a power P/2 will flow in both directions along the channel member 5. The microwaves in this example have a frequency of 2.4 GHz. These waves propagate along the channel member 5 in the H_{0,1} mode. This is seen in FIG. 2.

In use, a bulk material such as broken crisps is added to the bowl 4. As the apparatus vibrates, some of the material will start to move up the helical channel member 5. The bulk material moves along the helical channel member (waveguide) from the bottom to the top, and as it does so it is heated as it absorbs some of the energy stored in the microwaves. A profile of temperature against position is shown in FIG. 3. Most of the heating occurs as the material approaches the tee and as it then moves past the Tee. The heating is therefore gradual which ensures that the product does not experience thermal shock.

The apparatus provides a simple, efficient and controllable way of heating the product, the movement caused by the vibrations passing the material through the microwaves in the manner needed to give the desired heating and cooling profile.

Several modifications are possible. For example, the Tee feed need not be located at the centre of the channel member as shown. It could be located nearer the top or bottom. More than one Tee connection could be provided, enabling different heating profiles to be achieved along the length of the channel member. Different levels of power could be applied at each Tee.

Also, it can be seen in FIG. 1 that the helical channel member may be only semi-solid, having a solid base but cutaway top and upper sides. This is shown more clearly in FIG. 5(b). By semi-solid we mean that the top may be formed as a latticework. As long as the channel functions as a waveguide to retain most, or all, of the microwaves in the tube, then the cutaway can be formed in any shape desired. In fact, provided the holes are sized to provide evanescent attenuation to the microwave field the radiation can be retained in the channel and will not pass through the holes.

The main function of the lattice of FIG. 5(b) is to allow vapour and gasses given off by the heated solid products to escape easily for subsequent collection. It is envisaged that the cut-away will also make the tube easier to clean as a secondary advantage.

Other arrangements of channel member are shown in FIGS. 5(a) and 5(c) in which the channel member has solid walls, top and bottom, or is made entirely from walls which are semi-solid.

It should, of course, be understood that the invention does not have to be limited to helical vibratory conveyors. The channel may be linear, to provide a linear conveyor. For example, this could lie in a horizontal plane or could be tilted to give some elevation to the product as it moves from one end to the other.

The applicant envisages that the invention can be used to heat crisps, such as potato crisps, to a temperature at which oil in the crisps is released in liquid and/or vapour form for subsequent collection. This recovered oil can then be reused, perhaps in cooking, or as a biofuel for an engine.

It is also envisaged that the invention may have other application with different solid products. A non exhaustive list of possible solid products and the end products that can be realised by heating using the invention is given in Table 2. Protection may be sought for the use of the combined heating and conveying apparatus of the invention in a method of processing any of the solid products/materials listed in Table 2 as well as similar uses with other products.

TABLE 2

| Solid product/Material Processed | End product |
|---|---|
| Oranges, Lemons, Lavender etc | Essential oils and torrified waste |
| Wood biomass pellets | Torrified pellets |
| Flowers | Pollen recovered and dried flowers |
| Nuts | Internally dried nuts |
| Rice, hops and seeds | Evenly dried product |
| Meat and bonemeal | Dried product for food or fertiliser |
| Food waste (partially pre- | Gas and carbon |
| processed) | |
| Hospital waste | Gas and carbon |
| Waste crisps, other starchy | Oil recovered and possible feed |
| snacks and similar | |
| Fish waste | Fish oils and fish meal |
| Oil cuttings and shale | Oil recovered |
| Waste paint | Gases and resins |
| Filters from paint booths | Gases, resins and fibreglass |
| Tar sands | Bitumen, asphaltines and heavy oils |
| Road turnings | Reconstituted tarmac |
| Ship waste | Gases and inactive waste |
| Rockwool blocks for hydroponics | Reusable sterilised blocks |
| | with root mass reduced in volume |
| | by drying |
| Waste trichlorethylene | Cleansed trichlorethylene |
| Fibreglass from vehicle waste | Resin and gas |
| Tyres (shredded) | Carbon and wire for recycling |
| Carpet and vinyl flooring | Mostly gases |
| Coal | Dried coal |
| Compact discs/DVD's etc | Coating recovered |
| Sludges (of oil, pcbs, paint etc) | Cleansed gases |
| Computer parts | Metals and gases |

1. A combined heating and conveyor apparatus for use in heating a bulk solid product, such as a food product, comprising:
a hollow channel member having a base that forms a conveying surface along which said product is to be moved, said channel member having at least one entrance region and one discharge region;
an actuator which in use causes said channel member to vibrate in a manner which tends to cause said product introduced to said channel member at said entrance region to move towards said discharge region; and wherein:
said channel member functions as a microwave frequency closed waveguide; and
a source of microwave radiation is connected to said channel member in such a way that the microwave radiation propagates along said channel member and is substantially retained within said channel member whereby, in use, the energy in the microwaves can be at least partially absorbed by said product that passes along said channel member.

2. A combined heating and conveyor apparatus according to claim 1 wherein said channel member comprises a waveguide which is designed to work in an H0,1 mode.

3. A combined heating and conveyor apparatus according to claim 1 in which said channel member has an aspect ratio (height to width or width to height) of 2:1 or greater.

4. A combined heating and conveyor apparatus according to claim 1 wherein said channel member has electrically conductive walls.

5. A combined heating and conveyor apparatus according to claim 1 in which said channel member comprises a hollow metallic cylindrical conductor.

6. A combined heating and conveyor apparatus according to claim 1 in which at least part of said channel member is formed from at least one of a skeleton framework and a lattice of material to give access to an interior portion of side channel member for the extraction of any vapours and gasses that are given off during heating.

7. A combined heating and conveyor apparatus according to claim 1 wherein said channel member extends along a helical path, said channel member being oriented with one end of said channel member higher than the other, and said actuator is adapted to cause the channel to vibrate in a way that causes solid material to move from the lower end towards the higher end.

8. A combined heating and conveyor apparatus according to claim 7 in which said helical path is centred around a substantially vertical axis.

9. A combined heating and conveyor apparatus according to claim 1 in which said channel member comprises a plurality of interconnected sections.

10. A combined heating and conveyor apparatus according to claim 1 which further includes a feed through which bulk material can be fed to said channel member.

11. A combined heating and conveyor apparatus according to claim 1 wherein said microwave source is connected to said channel member through a waveguide which is connected to said channel member through a Tee junction or 3 db coupler located at a point along said channel member.

12. A combined heating and conveyor apparatus according to claim 11 wherein said microwave source is connected to said channel member midway along said channel member.

13. A combined heating and conveyor apparatus according to claim 1 wherein said actuator comprises at least one unbalanced motor, rotation of said at least one motor causing said apparatus to vibrate.

14. A combined heating and conveyor apparatus according to claim 1 in which said source of microwave energy emits radiation at a frequency that lies within the ISM frequency bands.

15. A method of heating a product comprising;
providing a product carrying channel which has the physical and electromagnetic properties required to function as a closed waveguide for microwave radiation;
vibrating said product carrying channel;
feeding product into one end of said product carrying channel, said product being carried to the other end of said channel by vibration of said product carrying channel; and
applying microwave energy to an inside of said product carrying channel such that said product absorbs at least part of said microwave energy as it passes along said channel.

16. A helical vibratory elevator which includes a feeder comprising a closed or semi-closed tube which functions as a microwave waveguide and which receives microwave radiation supplied from a microwave source.
